(19) United States
(12) Patent Application Publication
(10) Pub. No.: US 2007/0189800 A1
(43) Pub. Date: Aug. 16, 2007

(54) STICKING SUBSTANCE REMOVING APPARATUS AND IMAGE FORMING APPARATUS

(75) Inventor: Junichi USHIKUBO, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 11/625,356

(22) Filed: Jan. 22, 2007

(30) Foreign Application Priority Data
Feb. 10, 2006 (JP) 2006-034199

(51) Int. Cl. G03G 15/02

(52) U.S. Cl. 399/100; 399/176

(57) ABSTRACT

An image forming apparatus is provided capable of solving such problem of abrasion or load caused by the unevenness of installation position of cleaning member and capable of realizing excellent cleaning performance. A cleaning section in the image forming apparatus has a cleaning member with board shape which contacts with the surface of the charging roller through it's a first surface; and a fixing member which supports the cleaning member at least at an upstream side than a contact position between the charging roller and the cleaning member with respect to the rotation direction of the charging roller, the fixing member is formed so as to not contact with the cleaning member in an area of a second surface which is opposite to the contact part of the charging roller and the cleaning member.

### BACKGROUND OF THE INVENTION

1. Field of the Invention

The invention relates to a sticking substance removing apparatus to remove sticking substance sticking on the surface of an appointed rotating body and relates to an image forming apparatus comprising the sticking substance removing apparatus.

2. Related Background Art

Generally, an image forming apparatus with electrophotographic type is well known which heatedly fixes a toner image on a prescribed record medium and forms an image. In the concrete, such image forming apparatus, for example, irradiates light modulated according to image data corresponding to respective colors such as cyan, magenta, yellow, black or the like onto a charged image carrying body in order to form an electrostatic latent image; and develops the electrostatic latent image formed on the image carrying body through developers of respective colors. Then, the image forming apparatus, through sequentially transferring the developed developer images of respective colors onto the record medium, repeatedly adapts the developer images of respective colors and forms an color image.

Such image forming apparatus comprises a developer removing apparatus to remove developer adhering to the surface of a charging roller formed by a rotating body which contacts with the image carrying body to charge the image carrying body. The developer removing apparatus, for example, is provided as a part of a charging apparatus including the charging roller, and has a cleaning member furnished along a longitudinal direction of the surface of the charging roller. Then, the cleaning member is furnished between a wall surface on an opposite side of the charging roller, and the surface of the charging roller and is compressed (for example, see: patent document 1 and the like).

[patent document 1] JP-A-H03-101768.

However, in the conventional developer removing apparatus stated in the above patent document 1, because making the cleaning member contact with the charging roller in a state compressing in a radius direction of the charging roller, an unevenness of installation position of the cleaning member, specially, an unevenness of installation position with respect to the radius direction of the charging roller happened. Thus, a compression quantity of the cleaning member changes largely.

Thereby, in the conventional developer removing apparatus, specially, in the case that the installation position of the cleaning member happens unevenness with respect to a direction approaching the charging roller, because the compression quantity of the cleaning member unnecessarily becomes large, it is caused that abrasion of the cleaning member or load of the developer removing apparatus increases.

### SUMMARY OF THE INVENTION

It is, therefore, an object of the present invention to provide a developer removing apparatus capable of solving such problem of the abrasion or the load caused by the unevenness of the installation position of the cleaning member and capable of realizing excellent cleaning performance; and to provide an image forming apparatus comprising the developer removing apparatus.

According to the present invention, there is provided a sticking substance removing apparatus for removing sticking substance sticking on surface of an appointed rotating body, comprising:

a contacting member with board shape which has a first surface and a second surface, and contacts with the rotating body through the first surface; and

a supporting section which supports the contacting member at least at an upstream side than a contact position between the rotating body and the contacting member with respect to a rotation direction of the rotating body,

wherein the supporting section is formed so as to not contact with the contacting member at least in an area of the second surface which is opposite to a contact part of the rotating body and the contacting member.

Moreover, in the sticking substance removing apparatus, the supporting section may support the contacting member respectively at the upstream side and at a downstream side than a contact position between the rotating body and the contacting member with respect to a rotation direction of the rotating body.

Moreover, in the sticking substance removing apparatus, in the case that the first surface of the contacting member is in contact with the rotating body, in order to make a force which is added to the contacting member from the rotating body in a radius direction of the rotating body escape, the supporting section may include two supporting areas to respectively support the contacting member at the upstream side and at the downstream side than the contact position between the rotating body and the contacting member with respect to the rotation direction of the rotating body, and a predetermined space is formed by the two supporting areas.

Moreover, in the sticking substance removing apparatus, when setting a straight line distance corresponding to the contact part of the contacting member and the rotating body as a, setting a contact point approximately in center of the distance a as P, and setting an interval between the two supporting areas along a tangent line of the rotating body passing through the contact point P as A, the supporting section may be formed so as to meet a relation of A>a; when setting a maximum projection quantity of the contacting member caused by a pressure toward the radius direction of the rotating body at the contact point P as b, and setting a distance of the space of the supporting section in the radius direction of the rotating body at the contact point P as B, the supporting section may be formed so as to meet a relation of B>b.

Moreover, in the sticking substance removing apparatus, the supporting section is supporting the contacting member at the upstream side than the contact position between the rotating body and the contacting member with respect to the rotation direction of the rotating body; and the contacting member, when the first surface is in contact with the rotating body, may be formed so as to fall downward

Moreover, the sticking substance removing apparatus may further comprise a reinforcing member which is sandwiched between the second surface of the contacting member and the supporting section, and is used to reinforce the contacting member.

Moreover, in the sticking substance removing apparatus, the reinforcing member may have a greater bend elasticity coefficient than the contacting member.

Moreover, in the sticking substance removing apparatus, the rotating body may be belt shaped.

Moreover, in the sticking substance removing apparatus, the rotating body may be a charging roller to charge an image carrying body; and the contacting member may remove the sticking substance sticking on the surface of the charging roller.

Further, according to the present invention, there is provided an image forming apparatus for forming an image onto an appointed record medium, comprising:

an image forming section to develop an electrostatic latent image formed on an image carrying body through a sticking substance, and perform an image formation with respect to the record medium; and

a sticking substance removing section to remove sticking substance sticking on surface of an appointed rotating body,

wherein the sticking substance removing section includes:

a contacting member with board shape which has a first surface and a second surface, and contacts with the rotating body through the first surface; and

a supporting section which supports the contacting member at least at an upstream side than a contact position between the rotating body and the contacting member with respect to a rotation direction of the rotating body, the supporting section is formed so as to not contact with the contacting member at least in an area of the second surface which is opposite to a contact part of the rotating body and the contacting member.

### EFFECT OF THE PRESENT INVENTION

In the present invention, because the influence of abrasion or load caused by the unevenness of installation position of contacting member can be reduced, so it is possible to realize an excellent cleaning performance.

The above and other objects and features of the present invention will become apparent from the following detailed description and the appended claims with reference to the accompanying drawings.

### BRIEF DESCRIPTION OF THE DRAWINGS

FIG. 1 is a cross section showing a structure of an image forming apparatus in embodiment 1 of the present invention;

FIG. 2 is a front view diagram showing a structure of an image forming unit in an image forming apparatus in embodiment 1 of the present invention;

FIG. 3 is a front view diagram showing an important portion obtained by magnifying the circumference of a cleaning member in an image forming unit in FIG. 2;

FIG. 4 is a cubic diagram for an explanation about an arrangement of a cleaning member and a fixing member with respect to a charging roller in an image forming apparatus in embodiment 1 of the present invention;

FIG. 5 is a side view diagram showing a cleaning member in an image forming apparatus in embodiment 1 of the present invention;

FIG. 6 is a coordinate diagram showing an experiment result obtained by requesting a relation between a displacement quantity of an installation position of a cleaning member with respect to a radius direction of a charging roller and a load torque of an image carrying body which occurs through a cleaning member to contact in the case to use the cleaning member shown by FIGS. 2-5;

FIG. 7 is a front view diagram showing a structure of an image forming unit in a conventional image forming apparatus;

FIG. 8 is a front view diagram showing an important portion obtained by magnifying the circumference of a cleaning member in an image forming unit in FIG. 7;

FIG. 9 is a coordinate diagram showing an experiment result obtained by requesting a relation between a displacement quantity of an installation position of a cleaning member with respect to a radius direction of a charging roller and a load torque of an image carrying body which occurs through a cleaning member to contact in the case to use the cleaning member shown by FIGS. 7-8;

FIG. 10 is a front view diagram showing a structure of an image forming unit in an image forming apparatus in embodiment 2 of the present invention;

FIG. 11 is a front view diagram showing an important portion obtained by magnifying the circumference of a cleaning member in an image forming unit in FIG. 10;

FIG. 12 is a side view diagram showing a cleaning member in an image forming apparatus in embodiment 2 of the present invention;

FIG. 13 is a coordinate diagram showing an experiment result obtained by requesting a relation between a displacement quantity of an installation position of a cleaning member with respect to a radius direction of a charging roller and a load torque of an image carrying body which occurs through a cleaning member to contact in the case to use the cleaning member shown by FIGS. 10-12;

FIG. 14 is a front view diagram showing a structure of an image forming unit in an image forming apparatus in embodiment 3 of the present invention; and

FIG. 15 is a front view diagram showing an important portion obtained by magnifying the circumference of a cleaning member in an image forming unit in FIG. 14.

### DETAILED DESCRIPTION OF THE PREFERRED EMBODIMENTS

The following is to explain in detail concrete embodiments to which the present invention is applied through referring to drawings.

In the embodiments, an image forming apparatus comprising a developer removing apparatus (i.e. sticking substance removing apparatus) to removing toner serving as developer (i.e. sticking substance) sticking on the surface of a charging roller formed from a rotating body. In the following, a color image forming apparatus with electrophotography form of tandem type will be explained, in which, a plurality of image forming units furnishing respective image carrying bodies that correspond to respective colors are arranged in tandem.

First is to explain embodiment 1 regarding an image forming apparatus.

### Embodiment 1

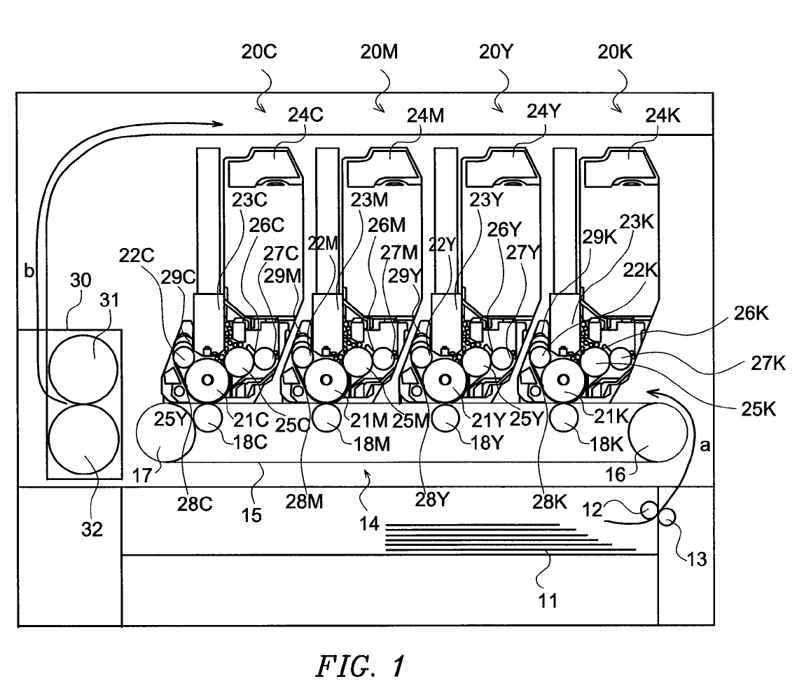

FIG. 1 is a cross section showing a structure of an image forming apparatus in embodiment 1 of the present invention.

An image forming apparatus is constructed as shown by FIG. 1. That is, the image forming apparatus comprises a paper providing tray 11 to accommodate record paper serving as record medium on which image is not be formed yet. The record paper accommodated in the paper providing tray 11 is sent out along a direction indicated by an arrow a in the same drawing in response to the rotations of paper providing rollers 12 and 13, and is conveyed in a predetermined timing to a transferring section 14 to form a medium conveyance route.

The transferring section 14 has a conveyance belt 15; a driving roller 16 which is driven by a belt motor (not shown); a belt idle roller 17 which rotates in response to movement of the conveyance belt 15 and provides tension so that the conveyance belt 15 does not occur relaxation; and transferring rollers 18K, 18Y, 18M and 18C to provide transfer voltages to image forming units 20K, 20Y, 20M and 20C that are attachable and removable, and are mentioned below. Moreover, the image forming units 20K, 20Y, 20M and 20C are sequentially arranged in tandem along the conveyance belt 15 toward paper output side of the record paper from paper providing side of the record paper; and while conveying the record paper by rotation forces of image carrying bodies 21K, 21Y, 21M and 21C and driving conveyance force of the conveyance belt 15, performs an image formation using respective colors with respect to the record paper put on the conveyance belt 15.

In the concrete, the image forming apparatus comprises the image forming units 20K, 20Y, 20M and 20C that are respectively facing to the transferring rollers 18K, 18Y, 18M and 18C so as to sandwich the conveyance belt 15 and respectively correspond to four colors of black (K), yellow (Y), magenta (M) and cyan (C).

The image forming units 20K, 20Y, 20M and 20C have the respective image carrying bodies 21K, 21Y, 21M and 21C on each an electroconductivity base layer made of, for example, Aluminium and the like and an outer layer made of organic photosensitive material are formed. In circumferences of the image carrying bodies 21K, 21Y, 21M and 21C, respective charging rollers 22K, 22Y, 22M and 22C are furnished as respectively contacting with the image carrying bodies 21K, 21Y, 21M and 21C. The charging rollers 22K, 22Y, 22M and 22C are respectively obtained by, for example, forming rubber material of semi-conductivity such as epichlorohydrin rubber and the like onto a metal shaft of electroconductivity in roll shape; and through being provided positive voltage or negative voltage by a predetermined power source controlled by a controlling section (not shown), make the respective surfaces of the contacting image carrying bodies 21K, 21Y, 21M and 21C uniformly be charged with electricity. Moreover, the image carrying bodies 21K, 21Y, 21M and 21C and the charging rollers 22K, 22Y, 22M and 22C are respectively arranged right and left along a rotation axis direction of the image carrying bodies 21K, 21Y, 21M and 21C, and respectively supported by a side frame (not shown).

Further, the image forming units 20K, 20Y, 20M and 20C comprise respective exposing sections 23K, 23Y, 23M and 23C, the exposing sections 23K, 23Y, 23M and 23C are furnished on the respective circumferences of the image carrying bodies 21K, 21Y, 21M and 21C, and have respective LED (Light Emitting Diode) heads to execute an exposure. The exposing sections 23K, 23Y, 23M and 23C respectively execute an exposure through irradiating light modulated on the basis of image data received from the outside onto the respective surfaces of the image carrying bodies 21K, 21Y, 21M and 21C, and respectively form an electrostatic latent image onto the respective image carrying bodies 21K, 21Y, 21M and 21C. Moreover, the exposing sections 23K, 23Y, 23M and 23C are supported by an upper cover member of the image forming apparatus, the upper cover member is operated to open or close while the image forming units 20K, 20Y, 20M and 20C or toner cartridges 24K, 24Y, 24M and 24C respectively are attached or removed with respect to the image forming apparatus.

Furthermore, the image forming units 20K, 20Y, 20M and 20C comprise respective developing rollers 25K, 25Y, 25M and 25C, the developing rollers 25K, 25Y, 25M and 25C are furnished on the respective circumferences of the image carrying bodies 21K, 21Y, 21M and 21C and contact with the respective image carrying bodies 21K, 21Y, 21M and 21C. The developing rollers 25K, 25Y, 25M and 25C are respectively obtained by forming rubber material of semi-conductivity such as silicon and the like onto a metal shaft of electroconductivity in roll shape; and through being provided positive voltage or negative voltage by a predetermined power source controlled by a controlling section (not shown), develop the respective electrostatic latent images formed on the contacting image carrying bodies 21K, 21Y, 21M and 21C by using toners of respective colors.

Further, on the respective circumferences of the developing rollers 25K, 25Y, 25M and 25C, developing blades 26K, 26Y, 26M and 26C are furnished, the developing blades 26K, 26Y, 26M and 26C are respectively used to uniformly limit a toner thin layer on the respective developing rollers 25K, 25Y, 25M and 25C, and respective ends of the developing blades 26K, 26Y, 26M and 26C contact with the respective developing rollers 25K, 25Y, 25M and 25C.

Furthermore, on the respective circumferences of the developing rollers 25K, 25Y, 25M and 25C, toner providing rollers 27K, 27Y, 27M and 27C are furnished, the toner providing rollers 27K, 27Y, 27M and 27C contact with the respective developing rollers 25K, 25Y, 25M and 25C and respectively provide toner to the developing rollers 25K, 25Y, 25M and 25C. Moreover, the toner providing rollers 27K, 27Y, 27M and 27C are respectively obtained by forming rubber material mixed foaming agent capable of improving conveyance ability of toner onto a metal shaft of electroconductivity in roll shape. The toner providing rollers 27K, 27Y, 27M, 27C and the developing blades 26K, 26Y, 26M, 26C are provided positive voltage or negative voltage by a predetermined power source. Moreover, the developing rollers 25K, 25Y, 25M and 25C, the developing blades 26K, 26Y, 26M and 26C, and the toner providing rollers 27K, 27Y, 27M and 27C are respectively arranged right and left along a rotation axis direction of the developing rollers 25K, 25Y, 25M and 25C, and respectively supported by a side frame (not shown).

Further, the image forming units 20K, 20Y, 20M and 20C comprise respective cleaning blades 28K, 28Y, 28M and 28C, the cleaning blades 28K, 28Y, 28M and 28C are furnished on the respective circumferences of the image carrying bodies 21K, 21Y, 21M and 21C and contact with the respective image carrying bodies 21K, 21Y, 21M and 21C. The cleaning blades 28K, 28Y, 28M and 28C remove transfer-residual toners that are respectively remaining on the surfaces of the image carrying bodies 21K, 21Y, 21M and 21C.

Furthermore, the image forming units 20K, 20Y, 20M and 20C comprise respective cleaning sections 29K, 29Y, 29M and 29C, the cleaning sections 29K, 29Y, 29M and 29C, as a developer removing apparatus, are furnished on the respective circumferences of the charging rollers 22K, 22Y, 22M and 22C and contact with the respective charging rollers 22K, 22Y, 22M and 22C. In the case that the transfer-residual toners are not completely removed from the respective surfaces of the image carrying bodies 21K, 21Y, 21M and 21C by the cleaning blades 28K, 28Y, 28M and 28C; then arrive and adhere on the respective surfaces of the charging rollers 22K, 22Y, 22M and 22C that are placed locate downstream positions in respective rotation direction of the image carrying bodies 21K, 21Y, 21M and 21C, the cleaning sections 29K, 29Y, 29M and 29C remove the respective adhering toners.

Through the image forming units 20K, 20Y, 20M and 20C toner images of respective colors are formed, then through a control of a control section (not shown) and the transferring rollers 18K, 18Y, 18M and 18C, with the respective rotations of the image carrying bodies 21K, 21Y, 21M and 21C, the toner image of respective colors are sequentially stacked and transferred on a record paper.

In the image forming apparatus, through the image forming units 20K, 20Y, 20M and 20C and the transferring section 14, image formations of respective colors are sequentially formed on the record paper, and a color image is formed. Then, in the image forming apparatus, in a state to electrostatically stick the record paper on the conveyance belt 15, the record paper is conveyed to a fixing section 30 which is placed a downstream position of the image forming units 20K, 20Y, 20M and 20C.

The fixing section 30 has a fixing roller 31 which, for example, is formed by gluing elastic member on outer surface of a hollow roller of metal; and a pressing roller 32 for pressing the record paper together with the fixing roller 31. The pressing roller 32 is furnished as facing the fixing roller 31 and being contacted with the fixing roller 31, further forms a nip portion to sandwich the record paper. Further, in the inside of the fixing roller 31, a halogen lamp to emit light through a power source (not shown) is laid. In the fixing section 30, under a control of a controlling section (not show) and through making the halogen lamp emit light, the fixing roller 31 is heated. The fixing section 30 makes the fixing roller 31 and the pressing roller 32 rotate in order to make the record paper pass through the nip portion, through heating and pressing the record paper, makes toner on the record paper melt and heatedly fixes a toner image. In the image forming apparatus, when the toner image is fixed on the record paper by such fixing section 30, through an electing roller (not show), the record paper is conveyed toward a direction shown by an arrow b in the same drawing and is ejected to outside, then is stacked on a predetermined stacker.

Moreover, because the image forming units 20K, 20Y, 20M and 20C, as stated above, use the toners with different colors but have the same structure, as a matter of convenience, below mark excluding the marks K, Y, M and C is used.

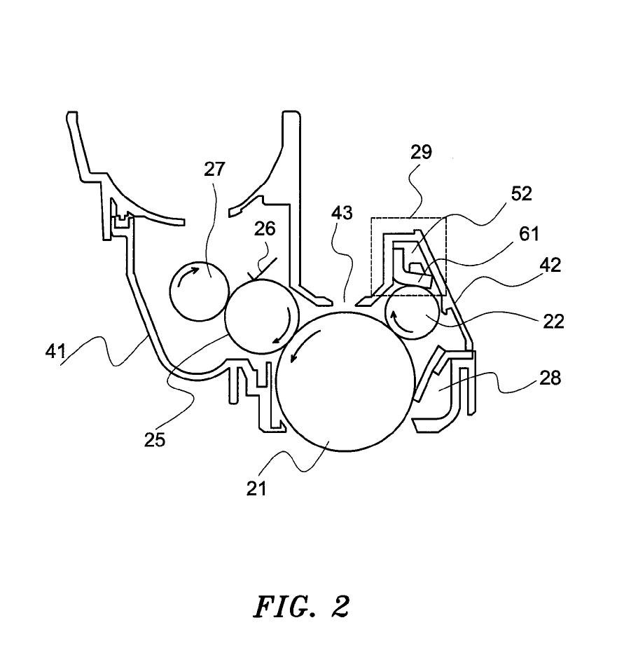

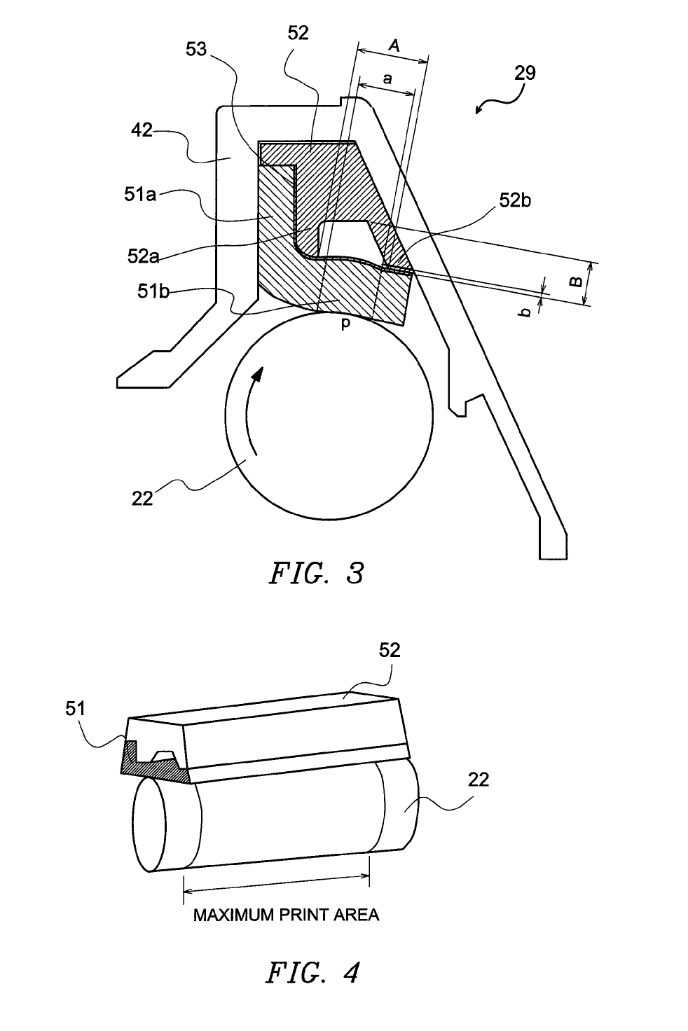

FIG. 2 is a front view diagram showing a structure of an image forming unit in an image forming apparatus in embodiment 1 of the present invention; and FIG. 3 is a front view diagram showing an important portion obtained by magnifying the circumference of a cleaning member in an image forming unit in FIG. 2.

The respective composition members of the image forming unit 20 in the image forming apparatus, as shown by FIGS. 2 and 3, are covered by a covering member 42 supported by a base frame member 41. On the covering member 42, in order to expose the image carrying body 21 by the exposing section 23, an opening portion 43 is furnished in a position which is downstream of the charging roller 22 and is upstream of the developing roller 25. Further, on the covering member 42, the cleaning section 29 serving as the developer removing apparatus is formed.

The cleaning section 29, as shown by FIG. 3, has a cleaning member 51 which serves as a contacting member to contact with the charging roller 22; and a fixing member 52 to fix the cleaning member 51. The cleaning member 51, for example, is adhesively fixed by the fixing member 52 via a both-sides tape. Moreover, in the embodiment, the covering member 42 and the fixing member 52 constructs a supporting section to support the cleaning member 51.

The cleaning member 51 is a member with board shape, has a first surface and a second surface, and contacts with the surface of the charging roller 22 through the first surface. In the concrete, one edge 51a of the cleaning member 51 adhered by the fixing member 52 is sandwiched between the covering member 42 and the fixing member 52. Further, a board shape plane portion 51b of the cleaning member 51 contacts with the surface of the charging roller 22. Moreover, the one edge 51a of the cleaning member 51 is placed at upstream side than a contact position between the charging roller 22 and the cleaning member 51 with respect to the rotation direction of the charging roller 22.

The fixing member 52 has a fixation foot portion 52a which is placed at upstream side than a contact position between the charging roller 22 and the cleaning member 51 with respect to the rotation direction of the charging roller 22; and a fixation foot portion 52b which is placed at downstream side than a contact position between the charging roller 22 and the cleaning member 51 with respect to the rotation direction of the charging roller 22. Through the fixation foot portion 52a and the fixation foot portion 52b, the cleaning member 51 can be adhesively supported. Here, in the case that the board shape plane portion 51b of the cleaning member 51 contacts with the charging roller 22, in order to make a force in roller radius direction adding onto the cleaning member 51 from the charging roller 22 escape to a space formed between the fixation foot portions 52a and 52b, the fixing member 52, for example, is formed in a concave shape.

That is, as shown by FIG. 3, when setting a straight line distance of a range in which the cleaning member 51 contacts with the charging roller 22 into a; setting a contact point in an approximate center of the distance a into P; and setting an interval between the fixation foot portion 52a and the fixation foot portion 52b along a tangent line direction of the charging roller 22 at the contact point P into a distance A, the fixing member 52 is formed so that the distance A is bigger than the distance a. Further, the fixing member 52 is formed so that a length of the space formed by the fixation foot portions 52a and 52b in the radius direction of the charging roller 22 is bigger than a maximum projection quantity of the cleaning member 51 caused by a pressure of the charging roller 22 at the contact point P. For example, in the fixing member 52 whose shape is shown by FIG. 3, if setting the maximum projection quantity of the cleaning member 51 caused by a pressure of the charging roller 22 at the contact point P into b; and setting the distance of the concave portion of the fixing member 52 in the radius direction of the charging roller 22 at the contact point P into B, the distance B is bigger than the distance b.

In the embodiment, in the case that the diameter of the charging roller 22 is 12 mm, the A is 4 mm (A=4 mm); the a is 3 mm (a=3 mm); the B is 3 mm (B=3 mm); and the b is 0.8 mm (b=0.8 mm). Moreover, if only the fixing member 52 has such space to meet the relations of A>a and B>b, other shapes excluding the concave shape may be used. That is, in the fixing member 52, the area which corresponds to the contact range of the charging roller 22 and the cleaning member 51 and faces the second surface of the cleaning member 51 does not contact with the cleaning member 51.

FIG. 4 is a cubic diagram for an explanation about an arrangement of a cleaning member and a fixing member with respect to a charging roller in an image forming apparatus in embodiment 1 of the present invention.

The cleaning member 51 and the fixing member 52, as shown by FIG. 4, are furnished along the longitudinal direction of the charging roller 22. In the case, the cleaning member 51 contacts with the charging roller 22 along a length more than width of maximum print area of the record paper.

FIG. 5 is a side view diagram showing a cleaning member in an image forming apparatus in embodiment 1 of the present invention.

The cleaning member 51, as shown by FIG. 5, can be formed by using sponge material of polyester kind whose thickness d is, for example, 3 mm (d=3 mm) and which is excellent to resist abrasion and resist climate. Moreover, the cleaning member 51 may be formed from such material having the same property as the sponge material of polyester kind, for example, felt material or other material can be used. Further, on one surface of the cleaning member 51, a both-sides tape 53 with an exfoliation paper 54 is stuck over the whole surface. When the both-sides tape 53 adheres to the fixing member 52, the exfoliation paper 54 is exfoliated. Moreover, the structure of the both-sides tape 53 is acceptable if only a part is adhered with respect to the fixing member 52. Further, in the present invention, the fixation method of the cleaning member 51 with respect to the fixing member 52 is not limited by the both-sides tape 53.

In the cleaning section 29, through forming the space of concave shape between the fixation foot portion 52a and the fixation foot portion 52b in the fixing member 52, with respect to the radius direction of the charging roller 22, even if the installation position of the cleaning member 51 is uneven and the cleaning member 51 is installed in a direction to approach the charging roller 22, because the force adding onto the board shape plane portion 51b of the cleaning member 51 escapes toward the radius direction of the charging roller 22, the compression quantity of the board shape plane portion 51b does not become big. That is, in the cleaning member 51, though the bend elasticity of itself, the board shape plane portion 51b certainly contacts with the charging roller 22.

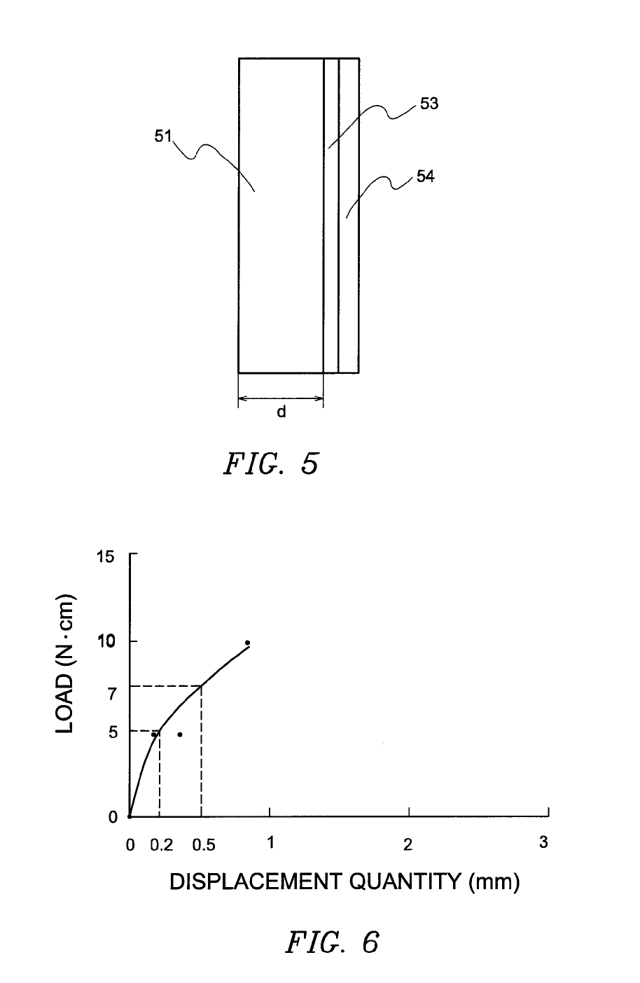

The applicant of the present invention executed an experimentation and obtained a relation between a displacement quantity of the installation position of the cleaning member 51 with respect to the radius direction of the charging roller 22 and a load torque of the image carrying body 21 caused by a contact of the cleaning member 51 and the charging roller 22. Moreover, in the experimentation, an installation position of the cleaning member 51 is measured when a load torque of the image carrying body 21 becomes “0”, and the installation position is decided to serve as a standard position whose displacement quantity is “0”. Then, in the case that the installation position of the cleaning member 51 displaces from the standard position toward the direction approaching the charging roller 22, the displacement quantity is obtained as positive value displacement quantity. An experiment result is shown by FIG. 6.

FIG. 6 is a coordinate diagram showing an experiment result obtained by requesting a relation between a displacement quantity of an installation position of a cleaning member with respect to a radius direction of a charging roller and a load torque of an image carrying body which occurs through a cleaning member to contact in the case to use the cleaning member shown by FIGS. 2-5.

In the FIG. 6, the displacement quantity of the installation position of the cleaning member 51 with respect to the radius direction of the charging roller 22 is indicated by a horizontal axis, and the load torque of the image carrying body 21 caused through a cleaning member to contact is indicated by a vertical axis.

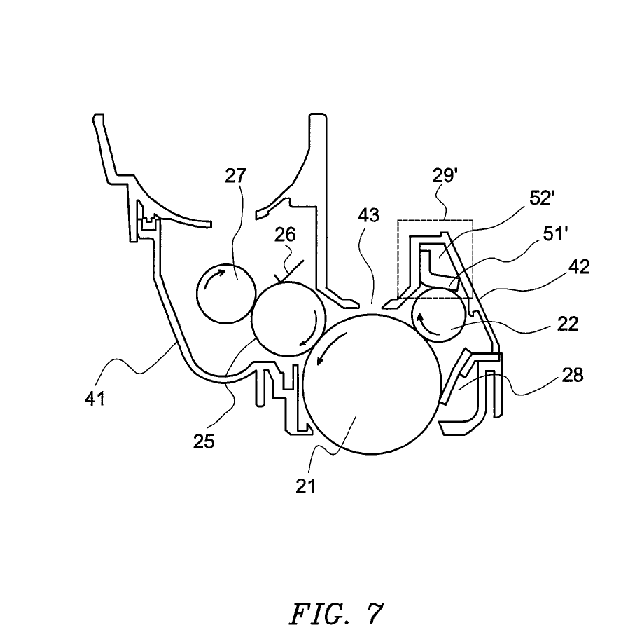

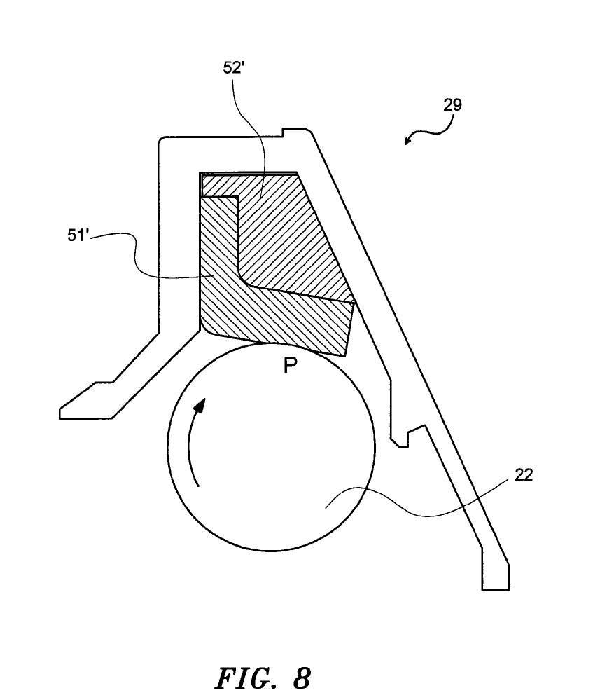

FIG. 7 is a front view diagram showing a structure of an image forming unit in a conventional image forming apparatus; and FIG. 8 is a front view diagram showing an important portion obtained by magnifying the circumference of a cleaning member in an image forming unit in FIG. 7.

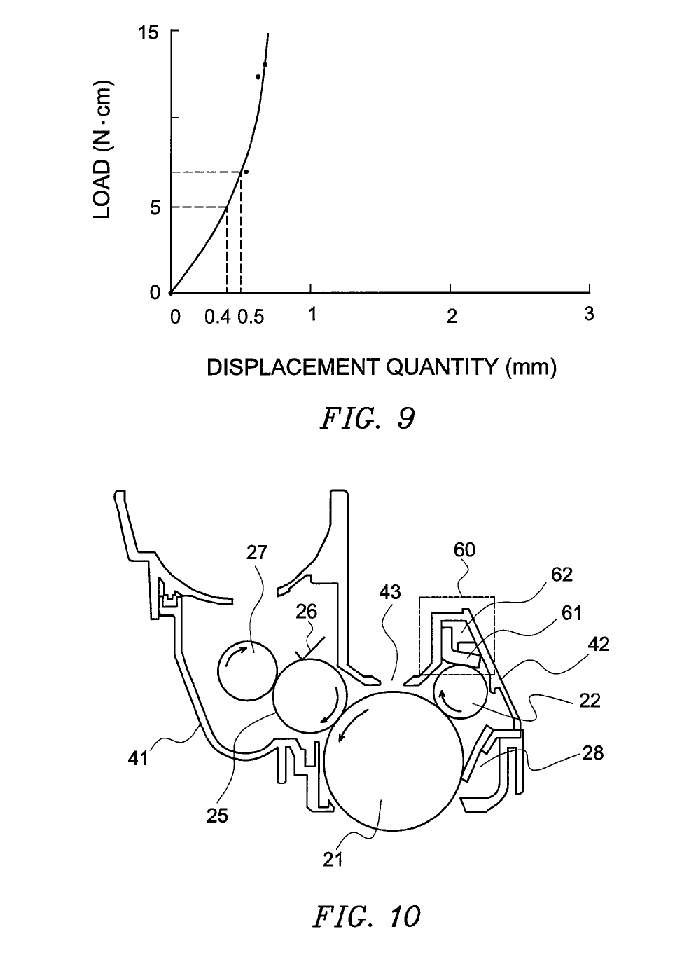

Further, in order to compare with the experiment result shown by FIG. 6, the applicant of the present invention made a cleaning section 29′ and made the same experiment. In the cleaning section 29′, a fixing member 52′ to form the cleaning section 29′ is formed with a shape having no the concave portion stated above, and a cleaning member 51′ and the fixing member 52′ are in contact overall along the surfaces. The cleaning section 29′ is used in conventional image forming apparatus, because the fixing member 52′ has the shape having no the concave portion, the cleaning member 51′ is to compressively contact with the charging roller 22. An experiment result in this case is shown by FIG. 9.

FIG. 9 is a coordinate diagram showing an experiment result obtained by requesting a relation between a displacement quantity of an installation position of a cleaning member with respect to a radius direction of a charging roller and a load torque of an image carrying body which occurs through a cleaning member to contact in the case to use the cleaning member shown by FIGS. 7-8.

As compared the FIG. 6 with the FIG. 9, in the case to use the cleaning section 29 in the embodiment, the inclination of the displacement quantity of the installation position of the cleaning member 51 with respect to the load torque of the image carrying body 21 is small, and even if the installation position is uneven, the change of the load torque of the image carrying body 21 is small. That is, in the image forming apparatus, as compared with the conventional image forming apparatus having the same displacement quantity, through using the cleaning section 29, the apparatus load is lightened, so that the influence to add the load caused by the unevenness of the installation position of the cleaning member 51 can be reduced.

In fact, in the image forming apparatus, the load torque of the image carrying body 21 is in a range of 5˜7 N·cm. Then to observe the experiment result on the basis of such load torque, in the experiment result of the FIG. 9, as the displacement quantity to meet that the load torque of the image carrying body 21 is in a range of 5˜7N·cm, it only is in a range of 0.5˜0.4 mm, that is, the unevenness of the displacement quantity is only limited within 0.1 mm. With respect to this, in the experiment result of the FIG. 6, as the displacement quantity to meet that the load torque of the image carrying body 21 is in a range of 5˜7 N·cm, it is in a range of 0.5˜0.2 mm, that is, the unevenness of the displacement quantity is limited within 0.3 mm, is greater than the 0.1 mm. Thereby, in the image forming apparatus, through using the cleaning section 29, it is possible to improve the margin of the installation position of the cleaning member 51.

Further, in the image forming apparatus, through using the cleaning section 29, a force to press against and contact with the charging roller 22 becomes small, so that it is possible to prevent the charging roller 22 from being damaged and to inhibit the abrasion.

Furthermore, in the image forming apparatus, because the one edge 51a of the cleaning member 51 is placed at upstream side than a contact position between the charging roller 22 and the cleaning member 51 with respect to the rotation direction of the charging roller 22, even if the cleaning member 51 is transformed on the downstream side of the rotation direction of the charging roller 22 because the charging roller 22 rotates, it is possible to keep in contacting state and to certainly clean the surface of the charging roller 22.

As stated above, in the image forming apparatus of the embodiment 1 of the present invention, through making the cleaning member 51 contact with the charging roller 22 by the bend elasticity of the cleaning member 51, the influence of abrasion or load caused by the unevenness of installation position of the cleaning member 51 can be reduced, so that it is possible to realize an excellent cleaning performance.

### Embodiment 2

The following is to explain an image forming apparatus in embodiment 2 of the present invention.

The image forming apparatus in embodiment 2 of the present invention is obtained by improving the image forming apparatus in the embodiment 1 of the present invention and by changing the shape of the fixing member to construct the cleaning section. Therefore, in the explanation of the embodiment 2, regarding the same compositions, they will use the same signs, and their detail explanation will be omitted.

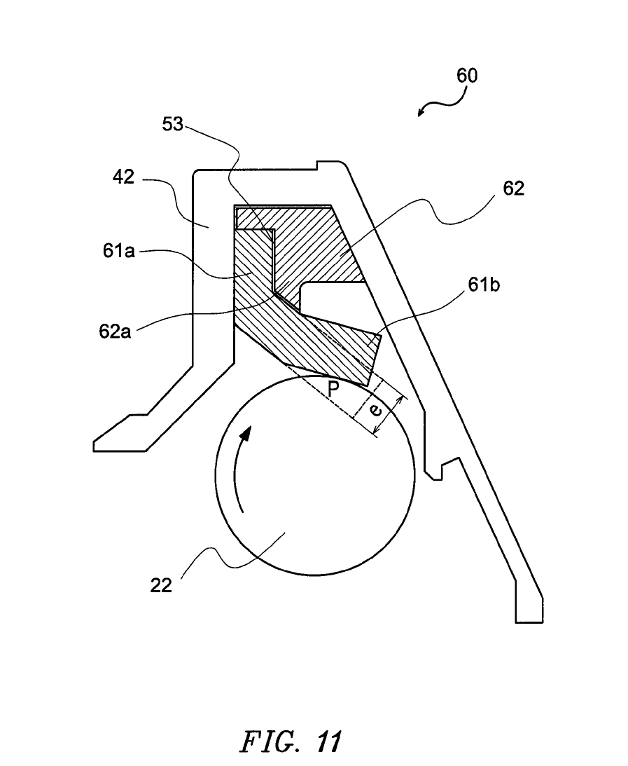

FIG. 10 is a front view diagram showing a structure of an image forming unit in an image forming apparatus in embodiment 2 of the present invention; and FIG. 11 is a front view diagram showing an important portion obtained by magnifying the circumference of a cleaning member in an image forming unit in FIG. 10.

The image forming unit 20 of the image forming apparatus has a cleaning section 60, the cleaning section 60, as shown by the FIGS. 10 and 11, is formed on the covering member 42 as the developer removing apparatus stated above.

The cleaning section 60, as shown by FIG. 11, has a cleaning member 61 which serves as a contacting member to contact with the charging roller 22; and a fixing member 62 to fix the cleaning member 61. The cleaning member 61, for example, is adhesively fixed by the fixing member 62 via the both-sides tape 53. Moreover, in the embodiment, the covering member 42 and the fixing member 62 constructs a supporting section to support the cleaning member 61.

The cleaning member 61 is a member with board shape, has a first surface and a second surface, and contacts with the surface of the charging roller 22 through the first surface. In the concrete, one edge 61a of the cleaning member 61 adhered by the fixing member 62 is sandwiched between the covering member 42 and the fixing member 62. Further, a board shape plane portion 61b of the cleaning member 61 contacts with the surface of the charging roller 22. The board shape plane portion 61b, when contacting with the charging roller 22, as shown by a broken line in the same drawing, falls down toward the radius direction of the charging roller 22. Moreover, the one edge 61a of the cleaning member 61 is placed at upstream side than a contact position between the charging roller 22 and the cleaning member 61 with respect to the rotation direction of the charging roller 22.

The fixing member 62 has a fixation foot portion 62a, through the fixation foot portion 62a, the fixing member 62 has a shape enabling the cleaning member 61 to be adhesively supported. Moreover, the fixation foot portion 62a is placed at upstream side than a contact position between the charging roller 22 and the cleaning member 61 with respect to the rotation direction of the charging roller 22.

The cleaning member 61 and the fixing member 62, as the cleaning member 51 and the fixing member 52 shown by FIG. 4, are furnished along the longitudinal direction of the charging roller 22. In the case, the cleaning member 61 contacts with the charging roller 22 along a length more than width of maximum print area of the record paper.

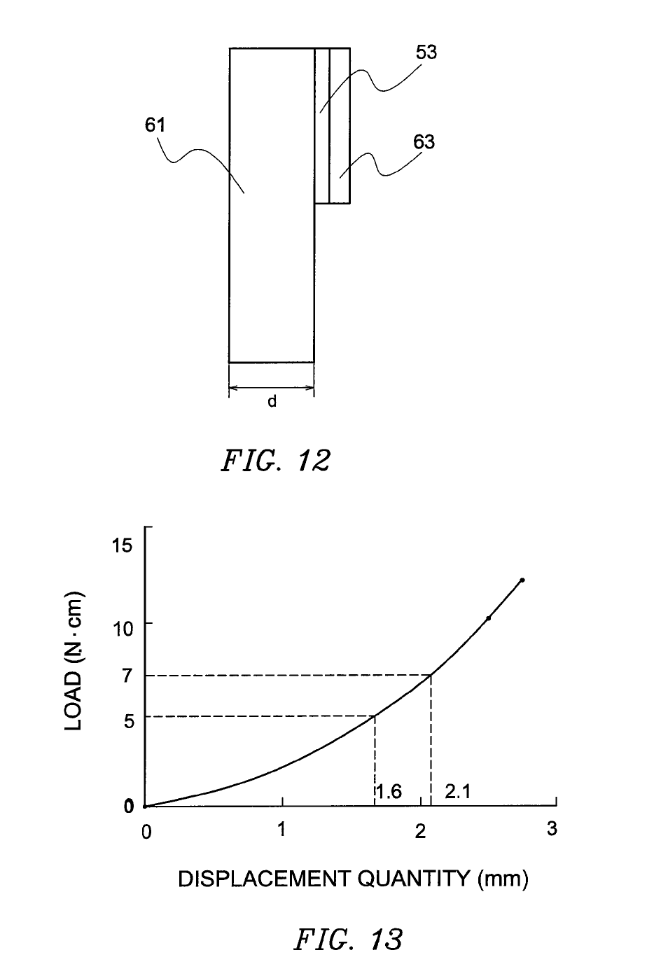

FIG. 12 is a side view diagram showing a cleaning member in an image forming apparatus in embodiment 2 of the present invention.

The cleaning member 61, as the cleaning member 5, can be formed by using sponge material of polyester kind which is excellent to resist abrasion and resist climate. Further, on one surface of the cleaning member 61, a both-sides tape 53 with an exfoliation paper 54 is stuck partly. When the both-sides tape 53 adheres to the fixing member 62, the exfoliation paper 54 is exfoliated. The sticking range of the both-sides tape 53 is set into a size to correspond to the sticking plane of the fixing member 62. Moreover, in the present invention, the fixation method of the cleaning member 61 with respect to the fixing member 62 is not limited by the both-sides tape 53. In the embodiment, in the case that the diameter of the charging roller 22 is 12 mm, the thickness d of the cleaning member 61 is 3 mm; when the board shape plane portion 61b of the cleaning member 61 falls downward the radius direction of the charging roller 22, the bend quantity e of the edge of the cleaning member 61 is 2.5 mm.

In the cleaning section 60, through forming a space between the fixation foot portion 62a and the covering member 42; forming the fixing member 62 so as to not contact with the cleaning member 61 in the area of the second surface opposite to the contact part between the charging roller 22 and the cleaning member 61; and forming the cleaning member 61 so as to fall downward the radius direction of the charging roller 22 in the case that the board shape plane portion 61b contacts with the surface of the charging roller 22, with respect to the radius direction of the charging roller 22, even if the installation position of the cleaning member 61 is uneven and the cleaning member 61 is installed in a direction to approach the charging roller 22, because the force adding onto the board shape plane portion 61b of the cleaning member 61 escapes toward the radius direction of the charging roller 22, the compression quantity of the board shape plane portion 61b does not become great. That is, in the cleaning member 61, though the bend elasticity of itself, the board shape plane portion 61b certainly contacts with the charging roller 22.

The applicant of the present invention executed an experimentation and obtained a relation between a displacement quantity of the installation position of the cleaning member 61 with respect to the radius direction of the charging roller 22 and a load torque of the image carrying body 21 caused by a contact of the cleaning member 61 and the charging roller 22. Moreover, in the experimentation, an installation position of the cleaning member 61 is measured when a load torque of the image carrying body 21 becomes “0”, and the installation position is decided to serve as a standard position whose displacement quantity is “0”. Then, in the case that the installation position of the cleaning member 61 displaces from the standard position toward the direction approaching the charging roller 22, the displacement quantity is obtained as positive value displacement quantity. An experiment result is shown by FIG. 13.

FIG. 13 is a coordinate diagram showing an experiment result obtained by requesting a relation between a displacement quantity of an installation position of a cleaning member with respect to a radius direction of a charging roller and a load torque of an image carrying body which occurs through a cleaning member to contact in the case to use the cleaning member shown by FIGS. 10-12.

In the FIG. 13, the displacement quantity of the installation position of the cleaning member 61 with respect to the radius direction of the charging roller 22 is indicated by a horizontal axis, and the load torque of the image carrying body 21 caused through a cleaning member to contact is indicated by a vertical axis.

As compared the FIG. 13 with the FIG. 6 stated in the embodiment 1, in the case to use the cleaning section 60 in the embodiment, the inclination of the displacement quantity of the installation position of the cleaning member 61 with respect to the load torque of the image carrying body 21 is small, and even if the installation position is uneven, the change of the load torque of the image carrying body 21 is more small. That is, in the image forming apparatus, through using the cleaning section 60, as compared with the conventional image forming apparatus having the same displacement quantity, the apparatus load is lightened, so that the influence to add the load caused by the unevenness of the installation position of the cleaning member 61 can be reduced.

Further, if observing the experiment result from the apparatus load, we can know that: in the experiment result shown by the FIG. 13, as a displacement quantity to meet that the load torque of the image carrying body 21 is in a range of 5˜7 N·cm, it only is in a range of 2.1˜1.6 mm, that is, the unevenness of the displacement quantity is limited within 0.5 mm. Thereby, as compared with the embodiment 1, it is possible to more improve the margin of the installation position of the cleaning member 61.

Further, in the image forming apparatus, through using the cleaning section 60, a force to press against and contact with the charging roller 22 becomes small, so that it is possible to prevent the charging roller 22 from being damaged and to inhibit the abrasion.

Furthermore, in the image forming apparatus, because the one edge 61a of the cleaning member 61 is placed at upstream side than a contact position between the charging roller 22 and the cleaning member 61 with respect to the rotation direction of the charging roller 22, even if the cleaning member 61 is transformed on the downstream side of the rotation direction of the charging roller 22 because the charging roller 22 rotates, it is possible to keep in contacting state and to certainly clean the surface of the charging roller 22.

As stated above, in the image forming apparatus of the embodiment 2 of the present invention, the influence of abrasion or load caused by the unevenness of installation position of the cleaning member 61 can be reduced, so that it is possible to realize an excellent cleaning performance.

### Embodiment 3

Finally, an image forming apparatus in embodiment 3 of the present invention will be explained.

The image forming apparatus in embodiment 3 of the present invention is obtained by improving the image forming apparatus in the embodiment 2 of the present invention and by changing the structure of the cleaning section. Therefore, in the explanation of the embodiment 3, regarding the same compositions, they will use the same signs, and their detail explanation will be omitted.

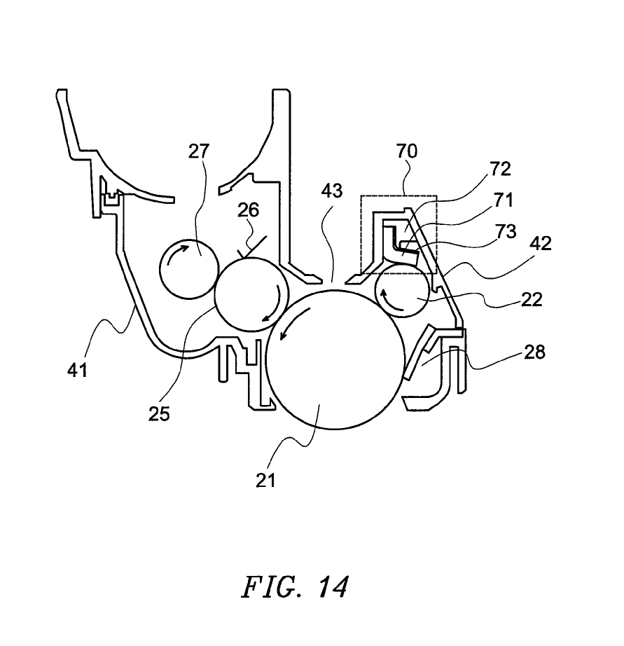

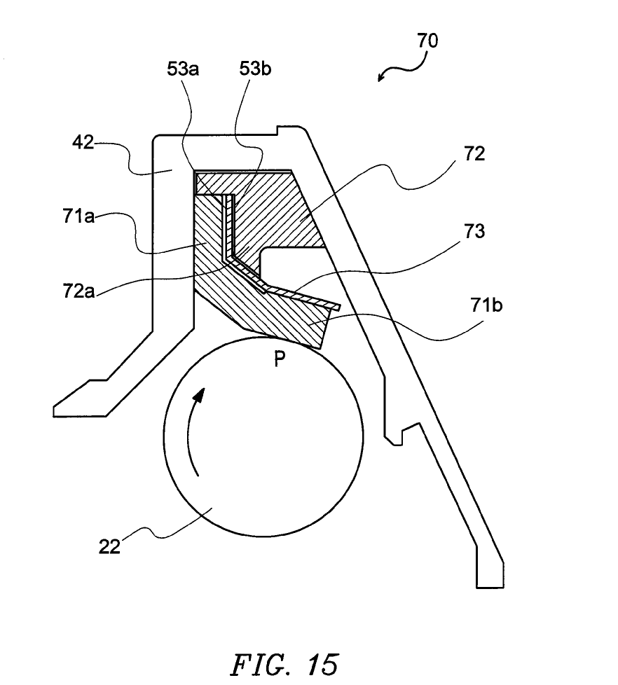

FIG. 14 is a front view diagram showing a structure of an image forming unit in an image forming apparatus in embodiment 3 of the present invention; and FIG. 15 is a front view diagram showing an important portion obtained by magnifying the circumference of a cleaning member in an image forming unit in FIG. 14.

The image forming unit 20 of the image forming apparatus has a cleaning section 70, the cleaning section 70, as shown by the FIGS. 14 and 15, is formed on the covering member 42 as the developer removing apparatus stated above.

The cleaning section 70, as shown by FIG. 15, has a cleaning member 71 which serves as a contacting member to contact with the charging roller 22; a fixing member 72 to fix the cleaning member 71; and a film member 73 which is placed between the cleaning member 71 and the fixing member 72 and serves as a reinforcing member to reinforce the cleaning member 71. The cleaning member 71, for example, is adhesively fixed by the film member 73 via the both-sides tape 53a. Moreover, in the embodiment, the covering member 42, the fixing member 72 and the film member 73 constructs a supporting section to support the cleaning member 71.

The cleaning member 71 is a member with board shape, has a first surface and a second surface, and contacts with the surface of the charging roller 22 through the first surface. In the concrete, one edge 71a of the cleaning member 71 adhered by the fixing member 72 is sandwiched between the covering member 42 and the film member 73. Further, a board shape plane portion 71b of the cleaning member 71 contacts with the surface of the charging roller 22. Moreover, the one edge 71a of the cleaning member 71 is placed at upstream side than a contact position between the charging roller 22 and the cleaning member 71 with respect to the rotation direction of the charging roller 22.

The fixing member 72, as the fixing member 62, has a fixation foot portion 72a. Through the fixation foot portion 72a, the fixing member 72 has a shape enabling the film member 73 on which the cleaning member 71 is adhesively fixed to be adhesively supported. Moreover, the fixation foot portion 72a is placed at upstream side than a contact position between the charging roller 22 and the cleaning member 71 with respect to the rotation direction of the charging roller 22.

The film member 73 is made out of, for example, polyester film, and is sandwiched between the cleaning member 71 and the fixing member 72. The sandwiched film member 73 approximatively has the same size as the one surface of the cleaning member 71, and extends to a downstream side of the rotation direction of the charging roller 22 than a contact position of the charging roller 22 and the cleaning member 71. Further, the film member 73 has a thickness capable of producing the same restitution force as that produced by a cleaning member whose thickness is a difference between a thickness of the cleaning member 71 and a thickness of the cleaning member 51 in the embodiment 1 or the cleaning member 61 in the embodiment 2.

For example, in the case that the diameter of the charging roller 22 is 12 mm, when the film member 73 with thickness of 0.1 mm is provided, with respect to such cleaning member 51 with thickness of 3 mm in the embodiment 1 or such cleaning member 61 with thickness of 3 mm in the embodiment 2, the cleaning member 71 can be thinned to 2 mm. That is, the film member 73, in the case that its thickness is 0.1 mm, produces the same restitution force as a cleaning member whose thickness is 1 mm. The film member 73, for example, is adhesively fixed by the cleaning member 71 and the fixing member 72 via both-sides tape 53a and both-sides tape 53b on its own both surfaces. Moreover, the fixation method of the cleaning member 71 with respect to the cleaning member 71 and the fixing member 72 is not limited by the both-sides tape. Further, in the cleaning section 70, as the film member 73, it may be made up of other elastic material such as board spring of metal-made having a bend elasticity coefficient greater than the cleaning member 71.

In the cleaning section 70, through forming a space between the fixation foot portion 72a and the covering member 42; and forming the fixing member 72 so as to not contact with the cleaning member 71 in the area of the second surface opposite to the contact part between the charging roller 22 and the cleaning member 71, with respect to the radius direction of the charging roller 22, even if the installation position of the cleaning member 71 is uneven and the cleaning member 71 is installed in a direction to approach the charging roller 22, because the force adding onto the board shape plane portion 71b of the cleaning member 71 escapes toward the radius direction of the charging roller 22, the compression quantity of the board shape plane portion 71b does not become great. That is, in the cleaning member 71, though the bend elasticity of itself and the bend elasticity of the film member 73, the board shape plane portion 71b certainly contacts with the charging roller 22.

As stated above, in the image forming apparatus of the embodiment 3 of the present invention, as compared with the image forming apparatus in the embodiment 2, even if using the cleaning member 71 whose thickness is thin, it is possible to obtain the same effects as the image forming apparatus in the embodiment 2. as a result, the image forming apparatus can be miniaturized.

Further, in the image forming apparatus, through changing the thickness and the material of the film member 73, without transforming the cleaning member 71, it is possible to change the pressing and contacting force with respect to the charging roller 22.

Moreover, the present invention is not limited in the above-stated embodiments. For example, in the above-stated embodiments, only such case to remove developer such as toner sticking on the surface of the charging roller is explained, however, the present invention also can be applied to other case to perform a cleaning of rotation body such as image carrying body being photo-sensitive drum or the like, transferring roller and the like. Further, the present invention also can be applied to such case to shave toner from developing roller. Furthermore, the present invention can be applied to such case to remove toner from transferring belt or photo-sensitive belt. That is, not only the present invention can be applied to rotation body of roller shape, but also the present invention can be applied to rotation body of belt shape.

Further, in the embodiments, only the toner, serving as a sticking substance, is removed, however, other sticking substance such as refuse, dust, useless matter or the like also can be removed. That is, not only the present invention can be applied to the case to remove sticking substance such as toner, but also the present invention can be applied to such case to remove the above-mentioned other sticking substance such as refuse, dust, useless matter or the like. As a result, the present invention can be widely applied for removing the sticking substance sticking on the surface of the rotation body.

Further, the present invention can be easily applied to, for example, printer has a conveying roller to convey record medium; facsimile apparatus; copying apparatus; multi-function apparatus having printing function, facsimile function and copying function; and the like.

The present invention is not limited to the foregoing embodiments but many modifications and variations are possible within the spirit and scope of the appended claims of the invention.

1. A sticking substance removing apparatus for removing sticking substance sticking on surface of an appointed rotating body, comprising:
a contacting member with board shape which has a first surface and a second surface, and contacts with said rotating body through said first surface; and
a supporting section which supports said contacting member at least at an upstream side than a contact position between said rotating body and said contacting member with respect to a rotation direction of said rotating body,
wherein said supporting section is formed so as to not contact with said contacting member at least in an area of said second surface which is opposite to a contact part of said rotating body and said contacting member.

2. The sticking substance removing apparatus according to claim 1,
wherein said supporting section supports said contacting member respectively at said upstream side and at a downstream side than a contact position between said rotating body and said contacting member with respect to a rotation direction of said rotating body.

3. The sticking substance removing apparatus according to claim 2,
wherein in the case that said first surface of said contacting member is in contact with said rotating body, in order to make a force which is added to said contacting member from said rotating body in a radius direction of said rotating body escape, said supporting section includes two supporting areas to respectively support said contacting member at said upstream side and at said downstream side than said contact position between said rotating body and said contacting member with respect to said rotation direction of said rotating body, a predetermined space is formed by said two supporting areas.

4. The sticking substance removing apparatus according to claim 3,
wherein when setting a straight line distance corresponding to said contact part of said contacting member and said rotating body as a, setting a contact point approximately in center of said distance a as P, and setting an interval between said two supporting areas along a tangent line of said rotating body passing through said contact point P as A, said supporting section is formed so as to meet a relation of A>a; when setting a maximum projection quantity of said contacting member caused by a pressure toward said radius direction of said rotating body at said contact point P as b, and setting a distance of said space of said supporting section in said radius direction of said rotating body at said contact point P as B, said supporting section is formed so as to meet a relation of B>b.

5. The sticking substance removing apparatus according to claim 1,
wherein said supporting section is supporting said contacting member at said upstream side than said contact position between said rotating body and said contacting member with respect to said rotation direction of said rotating body; and
said contacting member, when said first surface is in contact with said rotating body, is formed so as to fall downward.

6. The sticking substance removing apparatus according to claim 5, further comprising:
a reinforcing member which is sandwiched between said second surface of said contacting member and said supporting section, and is used to reinforce said contacting member.

7. The sticking substance removing apparatus according to claim 6,
wherein said reinforcing member has a greater bend elasticity coefficient than said contacting member.

8. The sticking substance removing apparatus according to claim 1,
wherein said rotating body is belt shaped.

9. The sticking substance removing apparatus according to claim 1,
wherein said rotating body is a charging roller to charge an image carrying body; and
said contacting member removes said sticking substance sticking on said surface of said charging roller.

10. An image forming apparatus for forming an image onto an appointed record medium, comprising:
an image forming section to develop an electrostatic latent image formed on an image carrying body through a sticking substance, and perform an image formation with respect to said record medium; and
a sticking substance removing section to remove sticking substance sticking on surface of an appointed rotating body,
wherein said sticking substance removing section includes:
a contacting member with board shape which has a first surface and a second surface, and contacts with said rotating body through said first surface; and
a supporting section which supports said contacting member at least at an upstream side than a contact position between said rotating body and said contacting member with respect to a rotation direction of said rotating body,
said supporting section is formed so as to not contact with said contacting member at least in an area of said second surface which is opposite to a contact part of said rotating body and said contacting member.
